(19) United States
(12) Patent Application Publication
(10) Pub. No.: US 2019/0316489 A1
(43) Pub. Date: Oct. 17, 2019

(54) SUPERCHARGER

(71) Applicant: ESS Performance Products A/S, Aremark (NO)

(72) Inventor: Asbjoern Boehn, Chandler, AZ (US)

(21) Appl. No.: 16/384,798

(22) Filed: Apr. 15, 2019

Related U.S. Application Data
(60) Provisional application No. 62/657,539, filed on Apr. 13, 2018.

(51) Int. Cl. F01D 25/24; F01M 1/02; F01D 25/14; F01D 25/18

(52) U.S. Cl. CPC F01D 25/24; F01M 1/02; F05D 2260/98; F01D 25/18; F01D 25/14

(57) ABSTRACT

Embodiments of the invention include a supercharger that has a compression chamber that includes an impeller at least partially positioned in the compression chamber, and a variable or interchangeable inlet extending from the housing that defines an inlet aperture fluidly coupled to the compression chamber. An oil baffle is included to control oil flow between input and impeller gears of a gear assembly.

### CROSS-REFERENCE TO RELATED APPLICATIONS

This application claims the benefit of and priority to U.S. Provisional Patent Application No. 62/657,539, filed Apr. 13, 2018, entitled SUPERCHARGER, the entire contents of which are incorporated herein by reference.

### BACKGROUND

Superchargers increase airflow to an engine that powers the supercharger. The increased airflow enables the engine to burn more fuel, which results in a commensurate increase in engine power. For example, a centrifugal supercharger uses a small impeller driven by the engine to draw air into the centrifugal supercharger from a fill side, compress the air in a compression chamber, and feed compressed air into the engine's combustion chamber via a discharge side. On most conventional superchargers, the pressure at the fill side is typically fixed, and does not allow for variations to optimize volumetric and thermal efficiency for specific applications. Moreover, internal lubrication of gearing involving transfer of power from the engine to the impeller is often sub-optimal and can affect longevity. Furthermore, some conventional assemblies can suffer from gear back-lash and gear noise associated with fluctuations in torque. Gear backlash can occur due to a gap between meshing gear contact surfaces (due to design tolerance and assembly and long-term wear of gear surfaces).

### SUMMARY

Some embodiments include an assembly comprising a housing at least partially enclosing a compression chamber, and a variably-sized inlet fluidly coupled to the compression chamber. Some embodiments further include an impeller at least partially positioned in the compression chamber. Some embodiments include an impeller shaft coupled to a portion of the impeller and forming an assembly, a portion of the assembly extending through an aperture of the housing. Some embodiments include an oil baffle positioned substantially in the housing and at least partially surrounding the aperture.

Some embodiments include a variably-sized inlet defined by an interchangeable or variable-size inlet constrictor. In some embodiments, the inlet constrictor comprises an inner wall defining an inlet region and outlet region, where a slope of the inner wall is defined by an angle from a plane parallel with the opening of the outlet region. In some embodiments, the slope is about 78°. In other embodiments, the slope is less than 90°.

In some embodiments, the housing comprises a scroll-like upper housing at one end and a gear housing at an opposite end. In some embodiments, the impeller is coupled to or integral with the impeller shaft, the impeller shaft is coupled to or integral with an impeller gear positioned adjacent the oil baffle. Some embodiments further comprise at least one oil guide including at least one coupled guide wall at least partially surrounding the impeller gear. Some embodiments comprise an anti-backlash gear assembly coupled to a gear of the impeller.

Some embodiments of the invention include an assembly comprising a fluid compression chamber fluidly coupled to an interchangeable or variable inlet constrictor, an input gear assembly comprising at least one input gear, an impeller gear coupled to one or more gears of the input gear assembly, and an oil baffle including guides configured to guide or control oil flow between the input gear and the impeller gear. In some embodiments, the inlet constrictor comprises an inner wall defining an inlet region and outlet region, wherein a slope of the inner wall is defined by an angle from a plane parallel with an opening of the outlet region. In some embodiments, the inlet constrictor is coupled to or includes an edge lip defining an inlet diameter of an inlet aperture. In some embodiments, the slope is about 78°. In other embodiments, the slope is about 90°.

Some further embodiments include at least one oil guide coupled to the oil baffle, where the at least one oil guide includes a curved wall at least partially surrounding the impeller gear. Some further embodiments comprise an anti-backlash gear assembly coupled to the impeller gear.

Some other embodiments include an assembly comprising a housing including an output aperture, a compression chamber at least partially surrounded by at least a portion of the housing, an impeller at least partially positioned in the compression chamber, and the impeller coupled to or including an impeller shaft coupled to an impeller gear. Further, some embodiments include a variable or interchangeable inlet constrictor defining an inlet aperture fluidly coupled to the compression chamber, and an oil baffle including guides configured to guide or control oil flow in an area located substantially between the input gear and impeller gear.

Some embodiments further comprise at least one oil guide integrally coupled to the oil baffle, wherein the inlet constrictor includes an outlet region comprising an aperture with an outlet diameter, the outlet diameter being circumferentially defined by a coupling between a bottom surface and an inner wall of the inlet constrictor. Further, in some embodiments, the inner wall is sloped by an angle from a plane parallel with the opening of the outlet region, the angle being at least about 78° or less than 90°.

### DESCRIPTION OF THE DRAWINGS

FIG. 1 illustrates a front perspective view of a supercharger in accordance with some embodiments of the invention.

FIG. 2 illustrates an exploded assembly top view of the supercharger of FIG. 1 in accordance with some embodiments of the invention.

FIG. 3 illustrates an exploded assembly bottom view of the supercharger of FIG. 1 in accordance with some embodiments of the invention.

FIG. 4 illustrates a bottom view of an input gear and anti-backlash gear assembly in accordance with some embodiments of the invention.

FIG. 5 illustrates top view of an input gear and anti-backlash gear assembly in accordance with some embodiments of the invention.

FIG. 6 illustrates a top perspective view of an input gear in accordance with some embodiments of the invention.

FIG. 7 illustrates a cross-sectional view through cut-line 7 of the input gear of FIG. 6 in accordance with some embodiments of the invention.

FIG. 8 illustrates a cross-sectional view through cut-line 8 of the input gear of FIG. 6 in accordance with some embodiments of the invention.

FIG. 9 illustrates a partial cut-away perspective assembly view of the supercharger of FIG. 1 with inlet area reducer (inlet ring) shown in accordance with some embodiments of the invention.

FIG. 10 illustrates a top view of the supercharger of FIG. 1 in accordance with some embodiments of the invention.

FIG. 11 illustrates a front cross-sectional view of the supercharger of FIG. 1 in accordance with some embodiments of the invention.

FIG. 12 illustrates a side cross-sectional view of the supercharger of FIG. 1 in accordance with some embodiments of the invention.

FIG. 13 illustrates a cross-sectional view through cut-line 13 of FIG. 12 in accordance with some embodiments of the invention.

FIG. 14 illustrates a cross-sectional view through cut-line 14 of FIG. 13 in accordance with some embodiments of the invention.

FIG. 15 illustrates a side cross-sectional view of an inlet area of the supercharger of FIG. 1 in accordance with some embodiments of the invention.

FIGS. 16-20 illustrate side cross-sectional views of inlet area reducers in accordance with some embodiments of the invention.

FIG. 21 illustrates a top perspective view of a gear housing with assembled input gear and impeller gear with oil guides in accordance with some embodiments of the invention.

FIG. 22 illustrates a top front perspective view of a gear housing with assembled input gear and impeller gear with oil guides in accordance with some embodiments of the invention.

FIG. 23 illustrates a top view of a gear housing with assembled input gear and impeller gear with oil guides in accordance with some embodiments of the invention.

FIGS. 24A and 24B illustrate perspective views of an oil baffle in accordance with some further embodiments of the invention.

FIG. 25 illustrates the oil baffle of FIGS. 24A and 24B positioned in a housing in accordance with some further embodiments of the invention.

FIG. 26 illustrates perspective view of the assembly of FIG. 25 with assembled input and impeller gears in accordance with some further embodiments of the invention.

FIG. 27 illustrates a front view of the assembly shown in FIG. 26 in accordance with some further embodiments of the invention.

FIG. 28 illustrates perspective view of the assembly of FIG. 25 with impeller gear and input gear shown in outline in accordance with some further embodiments of the invention.

FIG. 29 illustrates a baffled vent plug in accordance with some further embodiments of the invention.

FIG. 30 illustrates a section A-A of the baffled vent plug as defined in FIG. 29 in accordance with some further embodiments of the invention.

FIG. 31 illustrates an exploded assembly view of the baffle plug of FIG. 29 in accordance with some further embodiments of the invention.

FIG. 32 illustrates a front perspective view of the baffle plug of FIG. 29 in accordance with some further embodiments of the invention.

FIG. 33 illustrates a cross-sectional perspective view of the baffle plug of FIG. 29 in accordance with some further embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

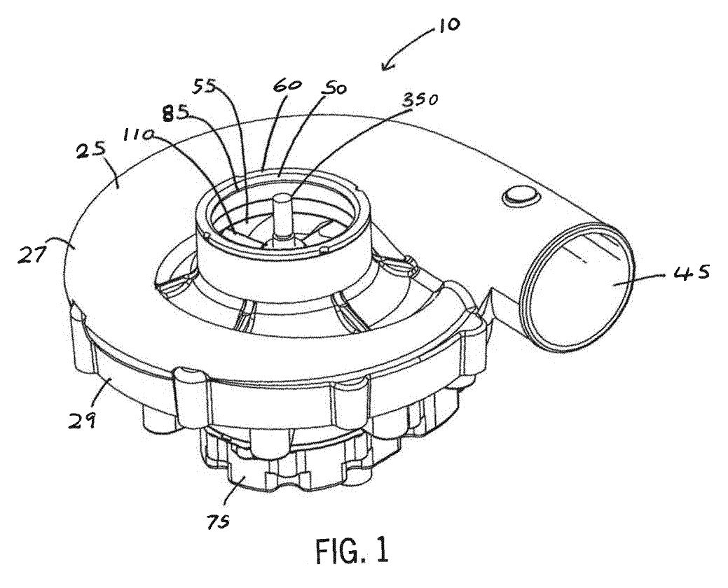

FIG. 1 illustrates a front perspective view of a supercharger 10 in accordance with some embodiments of the invention. In some embodiments, the supercharger 10 can comprise a housing 25 including an upper housing 27 at one end, and a gear housing 75 at an opposite end. Further, in some embodiments, a lower housing 29 can be positioned coupled to and between the upper housing 27 and the gear housing 75. The housing 25 can include a variety of assemblies and components that can enable the supercharger 10 to function to provide compressed gas or fluid (e.g., such as compressed air). In some embodiments of the invention, the supercharger 10 can include an inlet 50 through which ambient air can flow into a compression chamber 55 in the housing 25. In some embodiments, any ambient air flowing into the housing 25 can be compressed and fed or allowed to flow out of the housing 25 as compressed air. In some embodiments, any ambient air flowing into the housing 25 can be compressed within the housing 25 and fed into an engine to aid in increasing the power output of the engine.

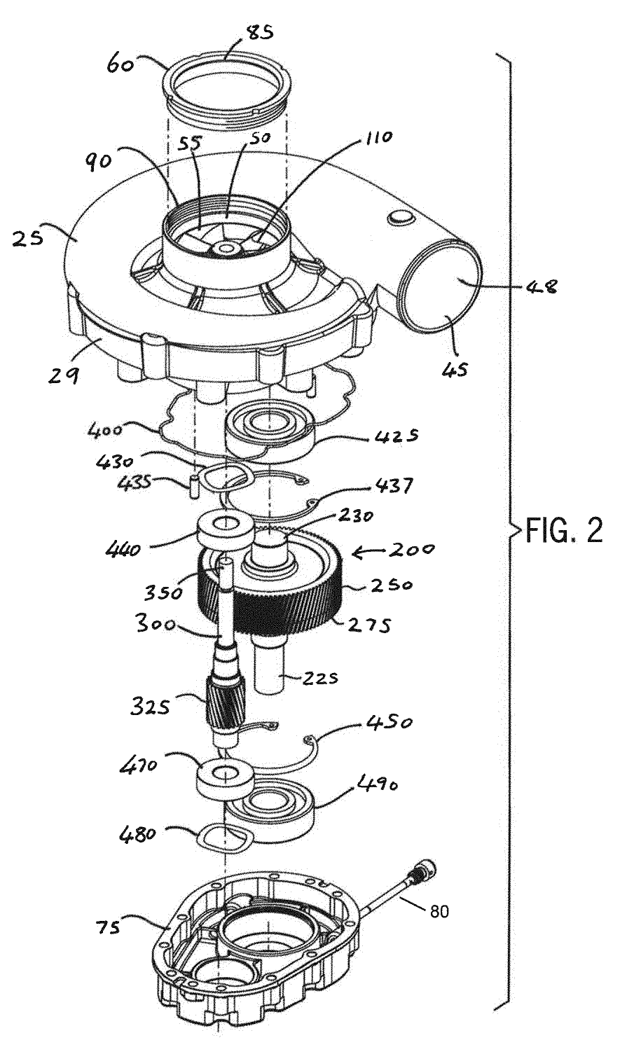

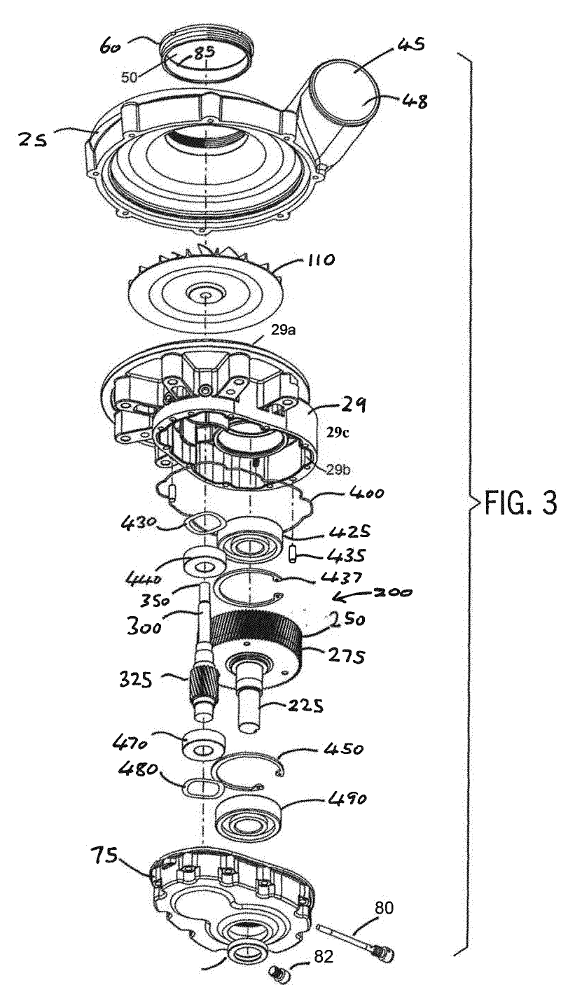

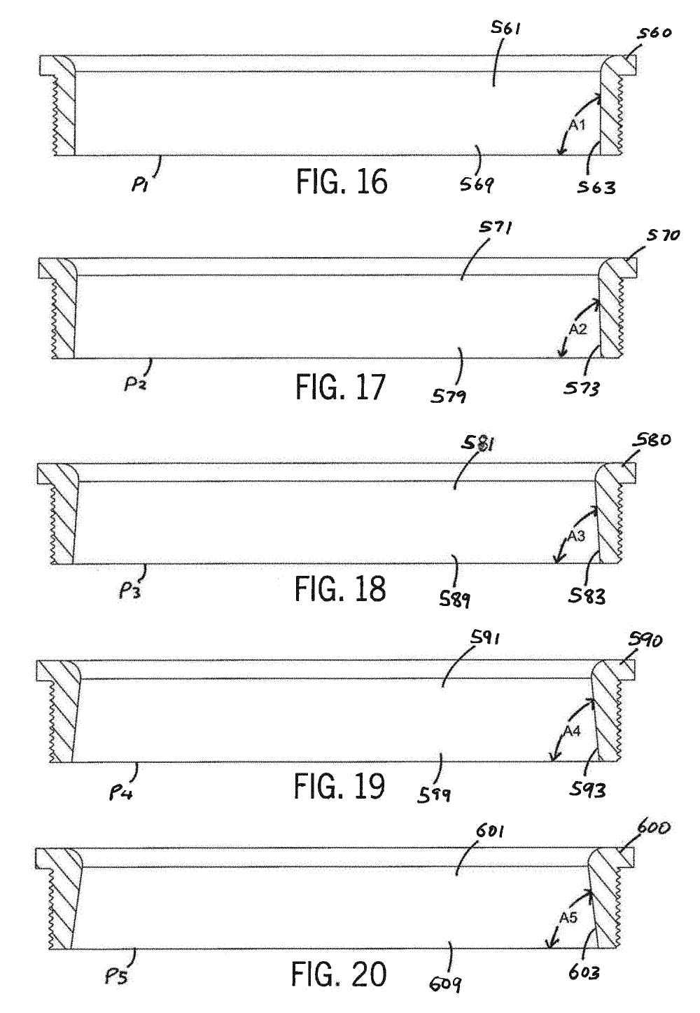

In some embodiments, the supercharger 10 can include an impeller 110 coupled to or integrated with an impeller shaft 350. The impeller 110 and associated drive components can be seen in more detail in the exploded assembly views of FIGS. 2 and 3. For example, FIG. 2 illustrates an exploded assembly top view of the supercharger 10 of FIG. 1 in accordance with some embodiments of the invention. FIG. 3 illustrates an exploded assembly bottom view of the supercharger 10 of FIG. 1 in accordance with some embodiments of the invention. In some embodiments, the inlet 50 can be at least partially defined by one or more inlet rings 60, and in some embodiments, the diameter of the inlet 50 can be varied using one or more inlet rings 60 of different diameters. For example, in some embodiments, the inlet 50 can include a variable inlet surface 85 that can be used to reduce, restrict, and/or throttle air flow into the inlet 50. Further details of the various embodiments of inlet rings 60 are shown and described below in relation to FIGS. 16-20.

In some embodiments of the invention, the impeller 110 can be mounted and/or supported in the housing 25 by the lower housing 29, which is shown from a bottom side in FIG. 3, and removed from the exploded assembly view of FIG. 2 for clarity purposes. For example, in some embodiments, the impeller 110 can be mounted in the upper end 29a of the lower housing 29. Further, in some embodiments, the impeller 110 can be coupled, or integrated with the impeller shaft 350 which can extend from the lower end 29b and through the upper end 29a of the lower housing 29. In some embodiments, impeller shaft 350 can be driven by a drive gear assembly to enable powered rotation of the impeller 110. In some embodiments of the invention, the impeller shaft 350 can comprise a central shaft 300 with a coupled or integral impeller gear 325. In some embodiments of the invention, the coupled or integrated impeller gear 325 can be positioned in the housing 25 coupled to one or more gears of an input gear assembly 200.

In some embodiments of the invention, the impeller shaft 350 and input gear assembly 200 can be positioned in the lower end 29b of the lower housing 29. Various components can be included to enable the impeller shaft 350 and input gear assembly 200 to be assembled into the lower housing 29. Some components include components for coupling one component to another component such as a fasteners or clips, and other components include components for providing seals. Still further, some other components can facilitate movement of shafts and/or gears such as bearings or bearing assemblies. For example, some embodiments include gasket 400 positioned and shaped to form a gasket seal between the lower end 29b of the lower housing 29 and top surface 77 of the gear housing 75.

Some further embodiments of the invention include a bearing assembly 425 configured to couple to the drive shaft 230. Further, some embodiments include gasket 430 positioned for coupling to the bearing assembly 440. In some embodiments, a fastener 435 can be positioned coupled into the lower housing 29. Further, some embodiments include a clip 437 positioned between the bearing assembly 425 and input gear 250, and/or clip 450 positioned adjacent the bearing assembly 490, and/or gasket 480 positioned adjacent the bearing assembly 470. Referring to the gear housing 75 of FIGS. 2 and 3, in some embodiments, the gear housing 75 can include a plug with dipstick 80 on one side of the gear housing 75, and a plug 82 (e.g., such as a drain plug) on an opposite of the gear housing 75.

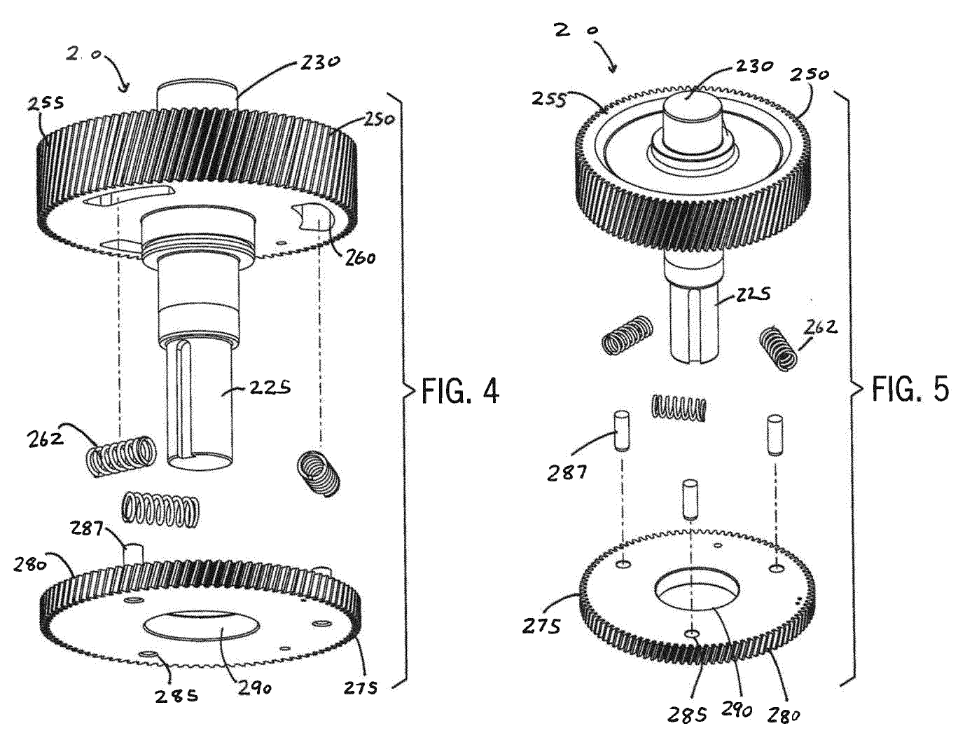

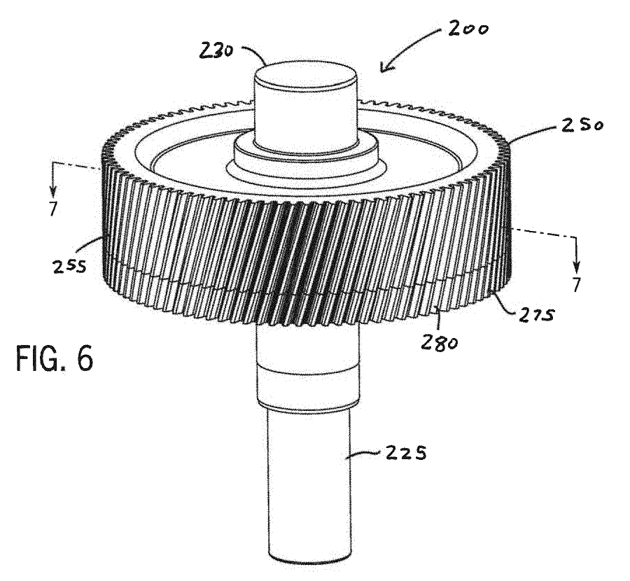

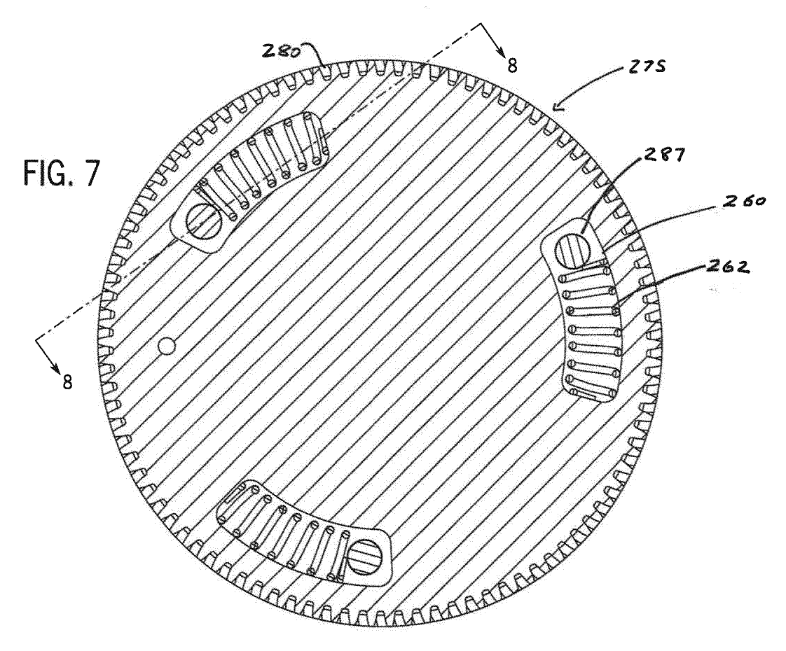

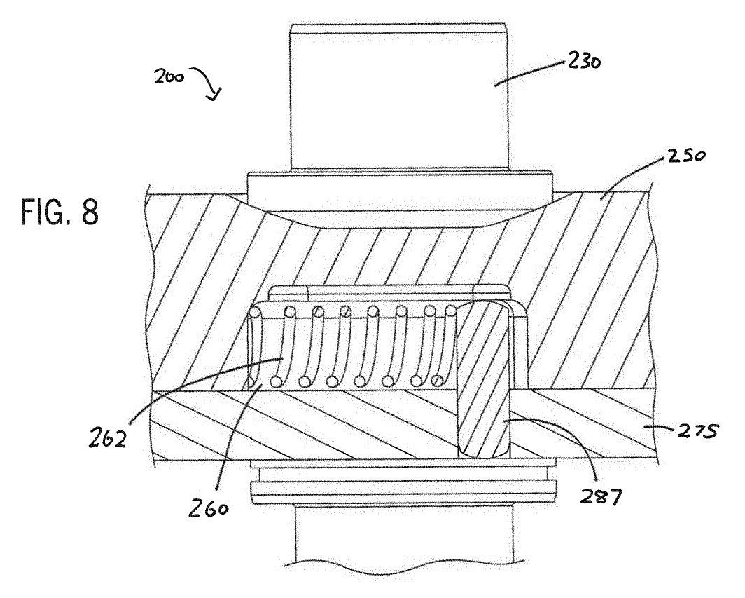

Some embodiments include assemblies to reduce gear back-lash and gear noise associated with fluctuations in torque. For example, some embodiments include a second adjacent, minor, or sub-gear that can be forced toward the rotational direction of the drive gear. The main or primary gear can be secured to the drive shaft, while the sub-gear can be mounted adjacent to the main gear (e.g., such as on a bushing). In some embodiments, the force can be applied using an assembly of springs that interconnects the two gears that can apply a spring-bias so that the teeth of the two gears can be out of alignment with respect to each other. In some anti-backlash gear assemblies, the combined out-of-alignment space of two misaligned teeth of each gear can be substantially the same as the space between two adjacent teeth on the gear with which the anti-backlash gears are meshed (e.g., such as impeller gear 325). For example, the input gear assembly 200 is shown further in FIGS. 4-7, where FIG. 4 illustrates an input gear 250 and a coupled anti-backlash gear 275 assembly bottom view in accordance with some embodiments of the invention, and FIG. 5 illustrates an input gear 250 and anti-backlash gear 275 assembly top view in accordance with some embodiments of the invention. FIG. 7 illustrates a cross-sectional view through cut-line 7 of the input gear of FIG. 6 in accordance with some embodiments of the invention, and FIG. 6 illustrates a top perspective view of an input gear in accordance with some embodiments of the invention. Further, FIG. 8 illustrates a cross-sectional view through cut-line 8 of the input gear of FIG. 6 in accordance with some embodiments of the invention.

In some embodiments of the invention, the input gear assembly 200 can include anti-backlash gear 275 positioned coupled to the input gear 250. In some embodiments, the assembly 200 can be assembled by passing the terminal end 225 of the drive shaft 230 through shaft aperture 290 of the gear 275. Some embodiments include an input gear assembly 200 comprising a drive shaft 230 coupled to or integrated with input gear 250 comprising teeth 255, and an anti-backlash gear 275 comprising teeth 280.

In some embodiments, the input gear 250 can include the three evenly circumferentially-spaced recesses 260 for positioning of biasing springs. In some non-limiting example embodiments, springs 262 can be positioned in the recesses 260 and coupled to pins 287 that are mounted into apertures 285. In some embodiments, this assembly can enable movement of the anti-backlash gear 275 relative to the input gear 250. For example, as the anti-backlash gear 275 rotates relative to the input gear 250, the pins 287 can compress the springs 262 when the anti-backlash gear 275 rotates relative to the input gear 250 in one direction. Further, as the anti-backlash gear 275 rotates relative to the input gear 250 in an opposite direction, the pins 287 can release the compressed springs 262 when the anti-backlash gear 275 rotates relative to the input gear 250 in the other direction. As a result, in some embodiments, the movement of the anti-backlash gear 275 relative to the input gear 250 can enable the meshing of the teeth 255 and/or the teeth 280 with the integrated impeller gear 325 with relatively low noise, chatter, misalignment, etc.

FIG. 7 illustrates a cross-sectional view through cut-line 7 of the input gear of FIG. 6 showing springs 262 positioned in the recesses 260 and coupled to pins 287. The non-limiting embodiment of FIG. 7 shows the springs 262 are arranged substantially evenly circumferentially spaced in the anti-backlash gear 275. The embodiment shows three springs 262, however it will be readily understood that the anti-backlash gear 275 can include less than three springs 262 or more than three springs 262, and that the springs 262 may not be substantially evenly spaced. The positional relationship of the springs 262 and pins 287 can be seen in FIG. 8 illustrating a cross-sectional view through cut-line 8 of the input gear of FIG. 6 in accordance with some embodiments of the invention.

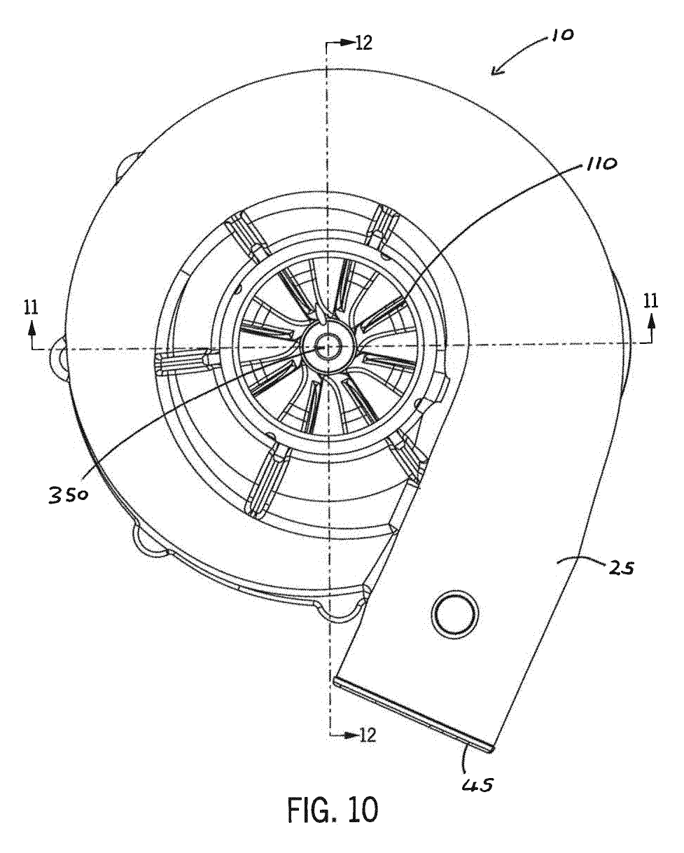

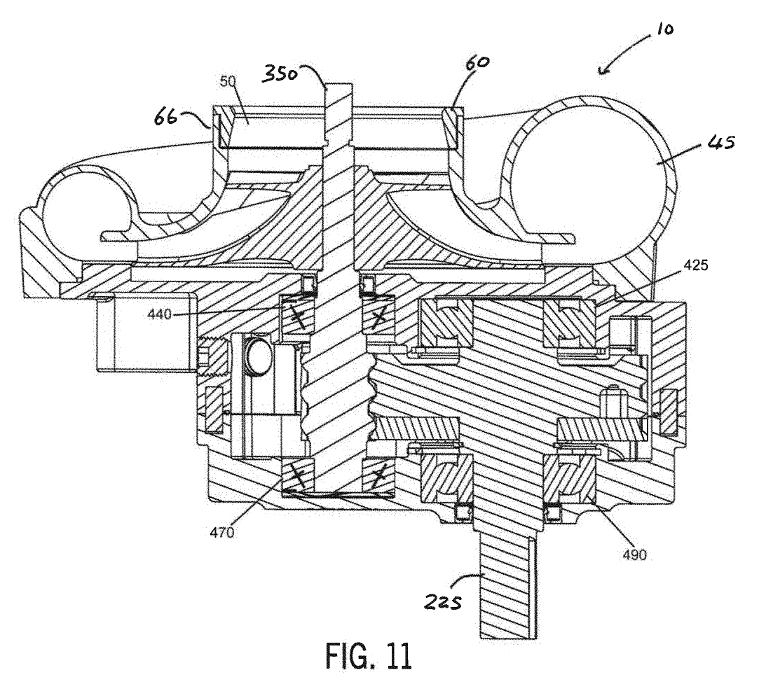

FIG. 10 illustrates a top view of the supercharger of FIG. 1 in accordance with some embodiments of the invention. During operation, the impeller 110 can rotate, drawing air into the housing 25 through the inlet 50. At least some of the air can be compressed by the impeller 110 and forced through the housing 25 towards an outlet aperture 45 defined by the housing 25. As shown, some embodiments include a housing 25 that comprises a scroll-like shape. In some embodiments the housing 25 can form part of a centrifugal or centrifugal-type supercharger. In other embodiments, the housing 25 can form part of a screw-type supercharger. In some embodiments, the internal cross-sectional diameter of the housing 25 can progressively increase in size from a region adjacent the impeller 110 within the housing and extending around the housing towards the outlet aperture 45. FIG. 11 illustrates a front cross-sectional view of the supercharger 10 of FIG. 1 in accordance with some embodiments of the invention where the internal cross-sectional diameter of the housing 25 is shown to be smaller on the left side of the image versus the right side, where the region of largest cross-sectional diameter defines the outlet aperture 45.

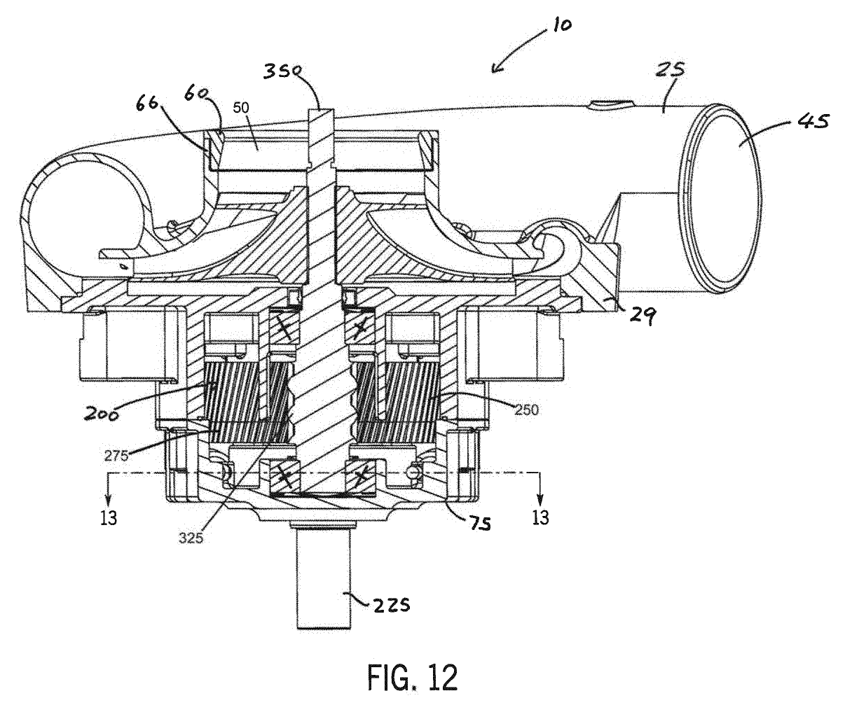

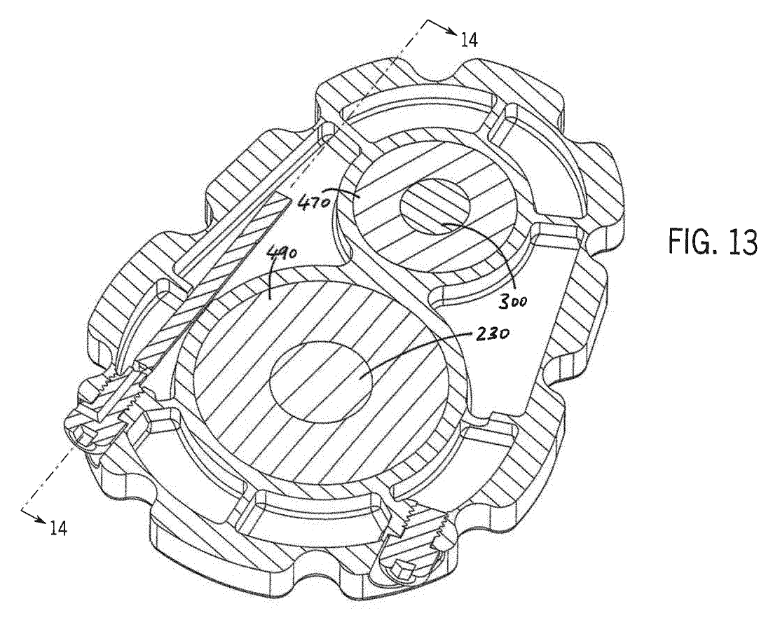

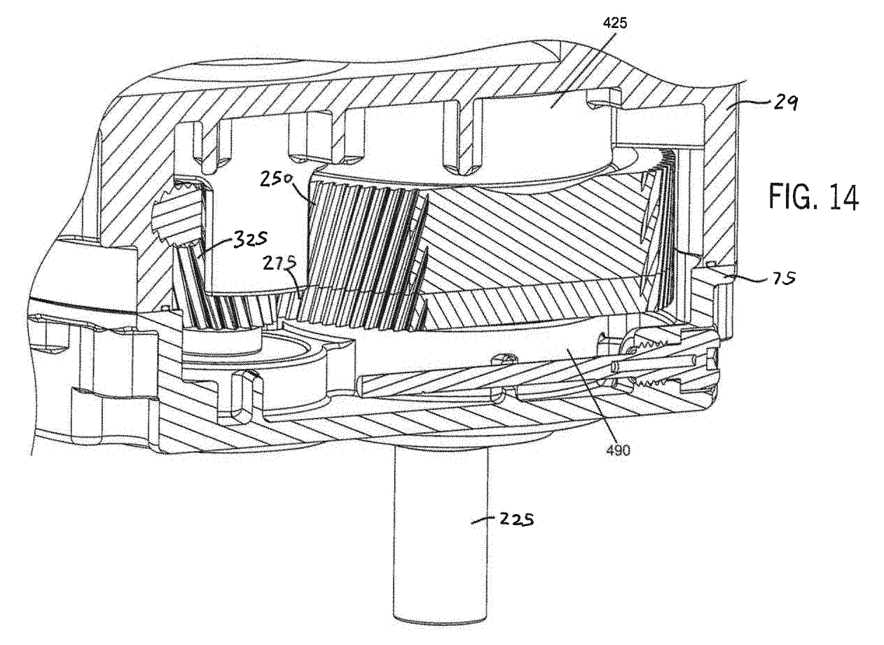

FIG. 12 illustrates a side cross-sectional view of the supercharger of FIG. 1 in accordance with some embodiments of the invention, and FIG. 13 illustrates a cross-sectional view through cut-line 13 of FIG. 12, and shows central shaft 300 of impeller shaft 350 of input gear assembly 200 coupled to bearing assembly 470, and drive shaft 230 coupled to bearing assembly 490. FIG. 14 illustrates a cross-sectional view through cut-line 14 of FIG. 13 in accordance with some embodiments of the invention, and shows the position of the input gear 250 and anti-backlash gear 275 positioned with respect to impeller gear 325. In some embodiments, the input gear assembly 200 can be powered to enable the impeller shaft 350 and impeller 110 to rotate. For example, drive shaft 230 coupled to or integrated with the teeth 255 of the input gear 250 can couple with teeth 280 of the anti-backlash gear 275 to drive transfer power from the drive shaft to the input gear 250 and anti-backlash gear 275.

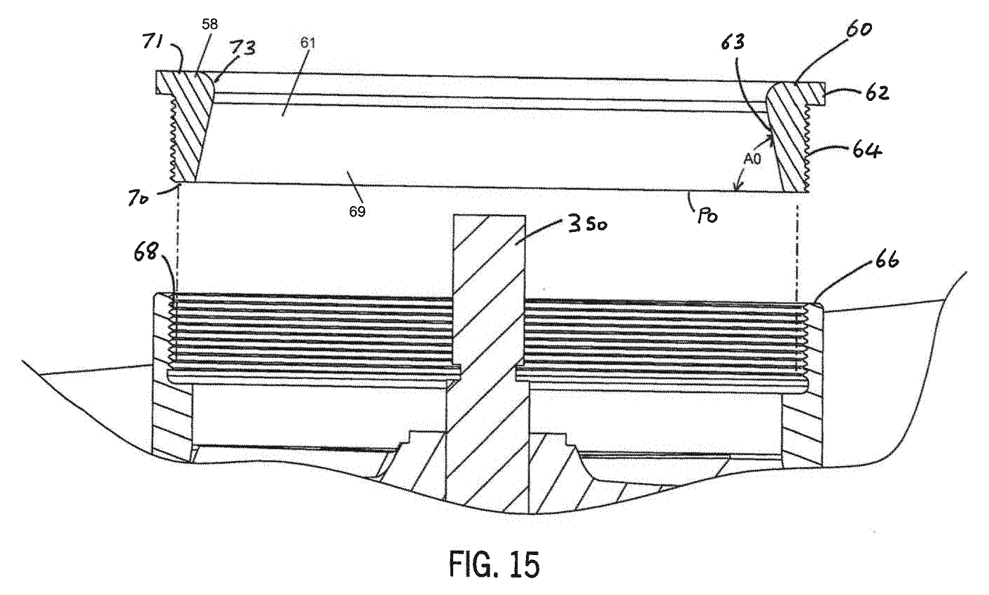

FIG. 15 illustrates a side cross-sectional view of an inlet area of the supercharger 10 of FIG. 1 in accordance with some embodiments of the invention. As described earlier, in some embodiments of the invention, the supercharger 10 can include an inlet 50 through which air can flow into compression chamber 55 where the inlet 50 can be defined by one or more inlets rings 60. In some embodiments, inlet constrictor 60 can comprise a main body 58 that can include an inner wall 63 extending from a bottom surface 70 to an edge lip 73 that extends circumferentially around the inlet constrictor 60 and defines an inlet diameter of the main body 58, and the outlet region 69 comprises an aperture with an outlet diameter that is circumferentially defined by the coupling between the bottom surface 70 and the inner wall 63 (i.e., the inner wall 63 defines circular aperture at a point where the inner wall 63 and bottom surface 70 meet). In some embodiments, the edge lip 73 extends from the top surface 71 to the inner wall 63.

In some embodiments, the edge lip 73 is coupled to and extends between the top surface 71 and the inner wall 63. In some embodiments, the inner wall 63 includes the edge lip 73. In some embodiments, the inlet diameter of the main body 58 (defined by the edge lip 73) is smaller than the outlet diameter as described above. In other embodiments, the inlet diameter (defined by the edge lip 73) is about equal to the outlet diameter. In some embodiments, the inlet constrictor 60 can include an outlet flange 62 extending outwardly from the main body 58, circumferentially around the inlet region 61. In some embodiments, the inlet constrictor 60 can be a ring or ring-like structure. In some other embodiments, the inlet constrictor 60 can comprise an oval or oval-shaped structure. In some further embodiments, the inlet constrictor 60 can comprise a square or rectangular structure or other desired shape.

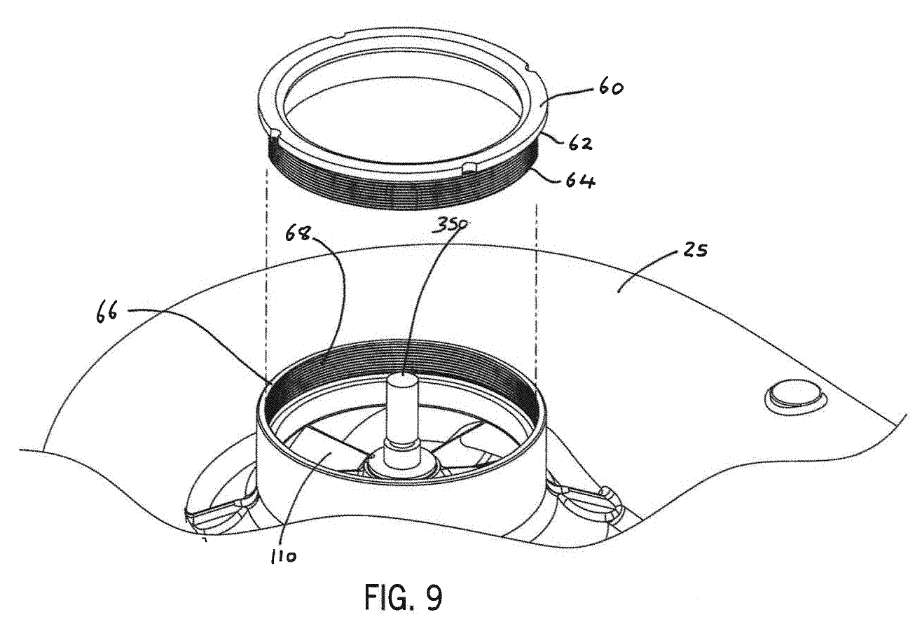

FIG. 9 illustrates a partial cut-away perspective assembly view of the supercharger 10 of FIG. 1 with the inlet constrictor 60 shown in accordance with some embodiments of the invention. In the non-limiting embodiment shown in FIG. 15, the edge lip 73 comprises a curved or convex surface. In some other embodiments, the edge lip 73 can have a smaller radius of curvature than shown, and in other embodiments, the edge lip 73 can have a larger radius of curvature than shown. Further, in some embodiments, the inlet constrictor 60 can include an inner wall 63 defining an inlet region 61 and outlet region 69. In some embodiments, the inlet constrictor 60 can include a constrictor thread 64 extending around an outer circumference of the main body 58. In some embodiments, the constrictor thread 64 can couple with a complementary inlet wall thread 68 extending circumferentially around the inlet wall 66 and assembled into the supercharger 10. In other embodiments, the inlet constrictor can be coupled to the supercharger in any other conventional way.

In some embodiments, the slope of the inner wall 63 can be defined by an angle A0 from a plane P0 parallel with the opening of the outlet region 69 (i.e. the plane P0 parallel with the bottom surface 70). For example, in some embodiments, the angle A0 between the inner wall 63 and the plane P0 can be about 78°. FIGS. 16-20 illustrate side cross-sectional views of inlet area reducers in accordance with some embodiments of the invention. For example, FIG. 16 illustrates a side cross-sectional view of inlet area reducer 560 in accordance with some embodiments of the invention. In some embodiments, the inlet constrictor 560 includes inner wall 563 defining an inlet region 561 and outlet region 569. In some embodiments, the slope of the inner wall 563 can be defined by an angle from a plane parallel with the opening of the outlet region 569. For example, in some embodiments, the angle A1 between the inner wall 563 and the plane P1 can be about 90°. In some other embodiments, the slope of the inner wall can be defined by an angle from a plane parallel with the opening of the outlet region that is less than about 90°. For example, FIG. 17 illustrates a side cross-sectional view of inlet area reducer 570 in accordance with some embodiments of the invention. Some embodiments include inlet constrictor 570 with an inner wall 573 defining an inlet region 571 and outlet region 579. In some embodiments, the slope of the inner wall 573 can be defined by an angle from a plane parallel with the opening of the outlet region 579. For example, in some embodiments, the angle A2 between the inner wall 573 and the plane P2 can be about 88°. Further, for example, FIG. 18 illustrates a side cross-sectional view of inlet area reducer 580 in accordance with some embodiments of the invention. In some embodiments, the inlet constrictor 580 includes an inner wall 583 defining an inlet region 581 and outlet region 589. In some embodiments, the slope of the inner wall 583 can be defined by an angle from a plane parallel with the opening of the outlet region 589. For example, in some embodiments, the angle A3 between the inner wall 583 and the plane P3 can be between about 86°. Further, for example, FIG. 19 illustrates a side cross-sectional view of inlet area reducer 590 in accordance with some embodiments of the invention. In some embodiments, the inlet constrictor 590 defines an inlet region 591 and outlet region 599 by the inner wall 593. In some embodiments, the slope of the inner wall 593 can be defined by an angle from a plane parallel with the opening of the outlet region 599. For example, in some embodiments, the angle A4 between the inner wall 593 and the plane P4 can be between about 84°. Further, for example, FIG. 20 illustrates a side cross-sectional view of inlet area reducer 600 in accordance with some embodiments of the invention. In some embodiments, the inlet reducer 600 defines an inlet region 601 and outlet region 609 by the inner wall 603. In some embodiments, the slope of the inner wall 603 can be defined by an angle from a plane parallel with the opening of the outlet region 609. For example, in some embodiments, the angle A5 between the inner wall 603 and the plane P5 can be between about 82°. In some embodiments, the slope of the inner wall can be defined by an angle from a plane parallel with the opening of the outlet region that is less than about 82°. For example, the slope of the inner wall can be defined by an angle from a plane parallel with the opening of the outlet region that is between about 78° and 82°, between about 75° and 78°, and so on. For example, in some embodiments, the slope of the inner wall can be defined by an angle from a plane parallel with the opening of the outlet region that is less than about 75°. In any of the embodiments described above, any one or more of angles A0 to A5 can vary from the values defined herein based on conventional manufacturing tolerances. For example, in some embodiments, any one or more of angles A0 to A5 can vary by about 0.01 degree to 0.1 degree or between about 0.01 degree and 0.5 degree based on manufacturing tolerances. In other embodiments, any of the embodiments described above with respect to angles A0 to A5 can vary from the values defined based on specifications of the supercharger. For example, in some embodiments, any one or more of angles A0 to A5 can vary by between about 0.1 and 0.5 degree, or between about 0.5 and 1 degree or more.

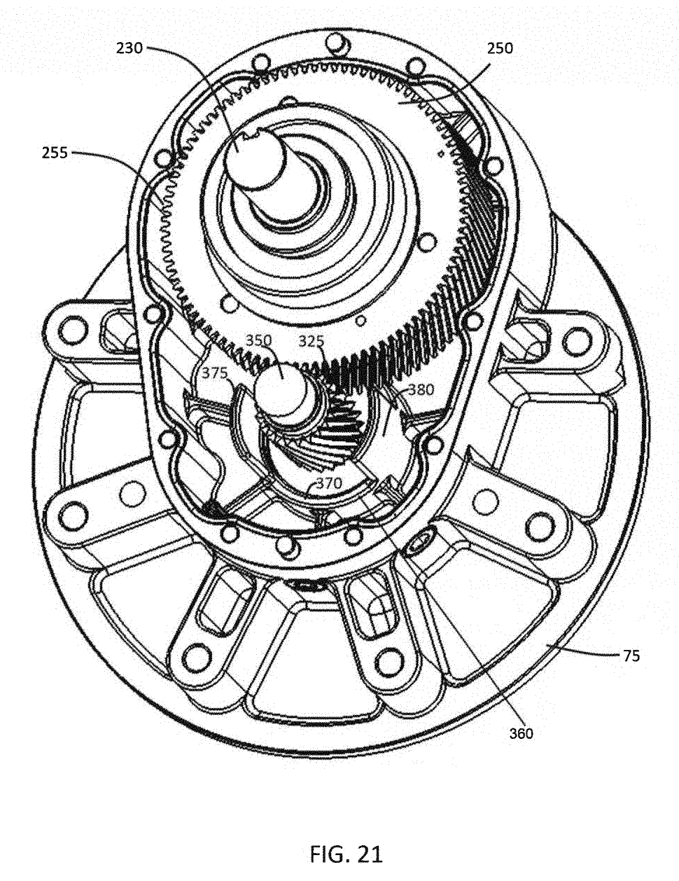

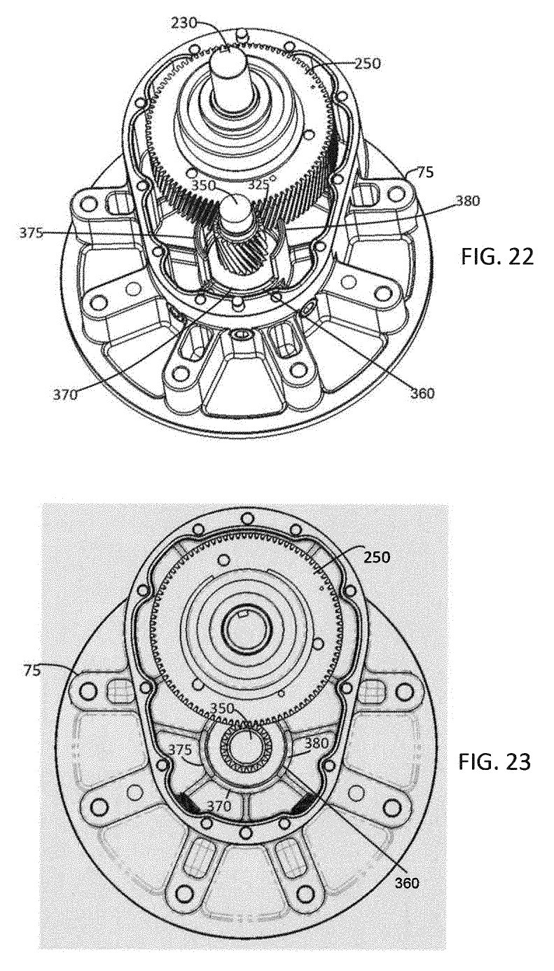

Some embodiments of the invention include one or more structures to guide flow of oil or other lubricant within the housing 25 of the supercharger 10. For example, FIG. 21 illustrates a top perspective view of a gear housing 75 with assembled input gear 250 and impeller gear 325 with oil guide 360 in accordance with some embodiments of the invention. Further, FIG. 22 illustrates a top front perspective view of the gear housing 75 with assembled input gear 250 and impeller gear 325 with oil guide 360 in accordance with some embodiments of the invention, and FIG. 23 illustrates a top view of a gear housing 75 with assembled input gear 250 and impeller gear 325 with oil guide 360 in accordance with some embodiments of the invention. As illustrated in FIGS. 21-23, in some embodiments, the oil guide 360 can be coupled to or can extend from the gear housing 75 towards the upper housing 27. In some embodiments of the invention, the oil guide 360 can comprise a base wall 370 extending at least partially around the impeller gear 325.

In some embodiments, the base wall 370 can comprise a curved wall as shown. In some embodiments, some portions of the base wall 370 can extend away from the gear housing 75 and towards the lower housing 29 and upper housing 27. For example, in some embodiments, the base wall 370 can include one or more coupled guide walls extending away from the gear housing 75. In some embodiments, the base wall 370 can include a coupled first guide wall 375 and/or a second guide wall 380. In some embodiments, the first guide wall 375 and/or the second guide wall 380 can extend circumferentially at least partially around the impeller gear 325. In some embodiments, the first guide wall 375 and/or the second guide wall 380 can extend at least a partial axial length of the impeller shaft 350. Further, in some embodiments, the first guide wall 375 and/or the second guide wall 380 can extend at least a partial axial length of the impeller gear 325. In the non-limiting example of FIGS. 21-23, the first guide wall 375 and/or the second guide wall 380 can comprise an axial length about equal to the axial length of the impeller gear 325. In some other embodiments, the first guide wall 375 and/or the second guide wall 380 can comprise an axial length less than the axial length of the impeller gear 325. In some further embodiments, the first guide wall 375 and/or the second guide wall 380 can comprise an axial length more than the axial length of the impeller gear 325.

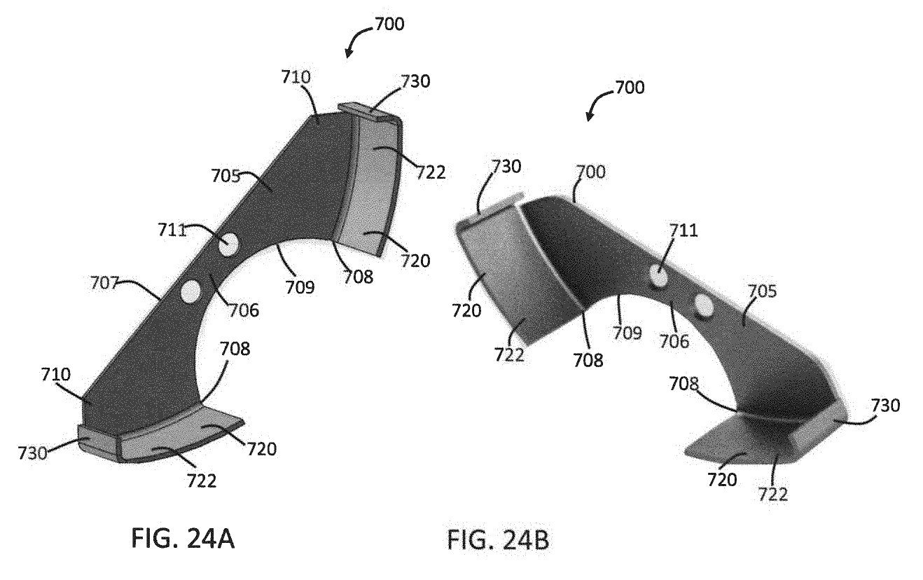

Some embodiments of the invention include structures to guide or control the flow or dispersion of fluid in the housing 25 within the supercharger 10 (e.g., lubricants such as gear oil). For example, FIGS. 24A and 24B illustrate a perspective view of an oil baffle 700 in accordance with some further embodiments of the invention. In some embodiments, oil baffle 700 can comprise a wall 705 including a top edge 707 on one side of the wall 705 and a lower edge 709 on an opposite side of the wall. As shown, in some embodiments, the oil baffle 700 can be a symmetrical structure comprising substantially identically-shaped ends 710. In some embodiments, the lower edge 709 can comprise a concave surface extending from inner edges 708 at each end of the oil baffle 700. In some embodiments, one or more apertures 711 can extend through the wall 705 as shown, positioned generally towards a mid-way region of the top edge 707. In some embodiments, the apertures 711 can be positioned closer together than shown, or can be further apart. In some embodiments, any of the apertures 711 can be positioned closer to the lower edge or closer to the top edge 707 than shown in the non-limiting embodiment of FIGS. 24A and 24B.

In some embodiments, each end of the oil baffle 700 can comprise guides 720. In some embodiments, the inner edges 708 can be convex edges from which can extend the guides 720 extending from the inner surface 706 of the wall 705. Therefore, in some embodiments, the inner surfaces 722 can comprise convex surfaces extending from the inner edge 708. In some embodiments, guides 720 can comprise extensions 730 extending from upper ends 724 of the guides 720, where the extensions 730 extend from the inner surfaces 722. In some embodiments, the length of the guides 720 extending along the inner edge 708 can vary based on the radius of curvature of the lower edge 709. For example, in some further embodiments, the radius of curvature of the lower edge 709 can be smaller, and the length of the guides 720 extending along the inner edge 708 from the upper ends 724 can be larger than illustrated. Conversely, in some other embodiments, the radius of curvature of the lower edge 709 can be larger, and the length of the guides 720 extending along the inner edge 708 from the upper ends 724 can be smaller than shown. Further, the length of the extensions 730 extending from the inner surfaces 722 can vary, with some embodiments including longer or short extensions 730 than illustrated in FIGS. 24A and 24B. Furthermore, in the non-limiting example illustrated, the extensions 730 are substantially equal in their length extending from the inner surfaces 722. In some embodiments, the length of the extensions 730 extending from the inner surfaces 722 can vary at each of the ends 710.

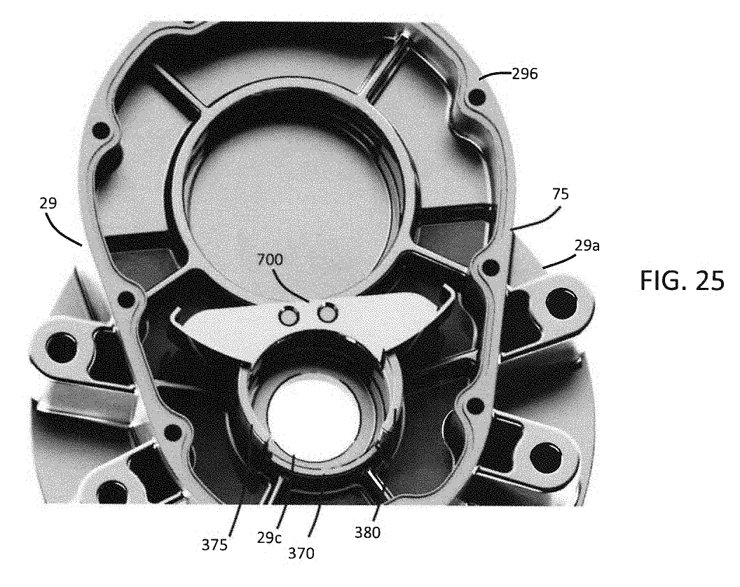

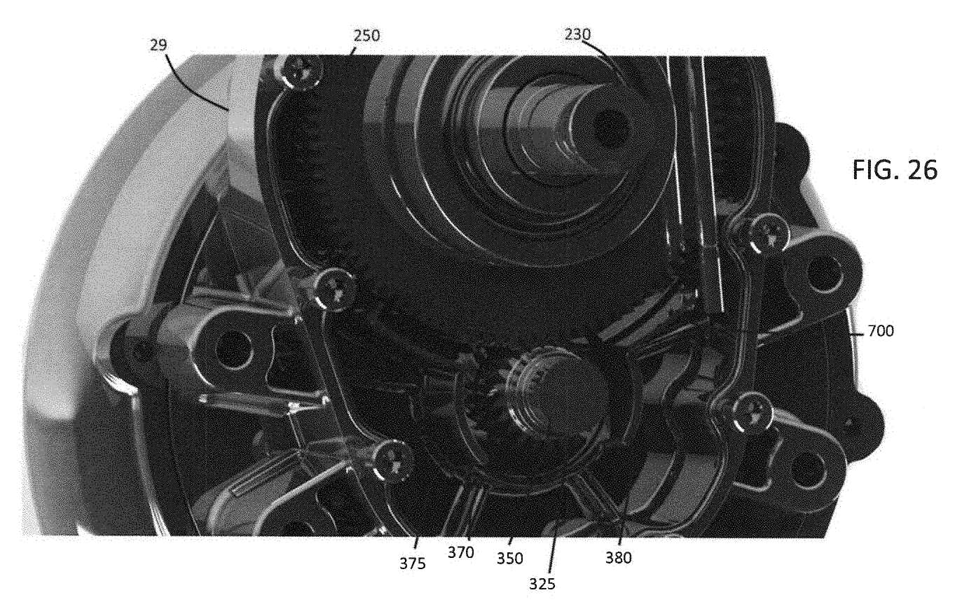

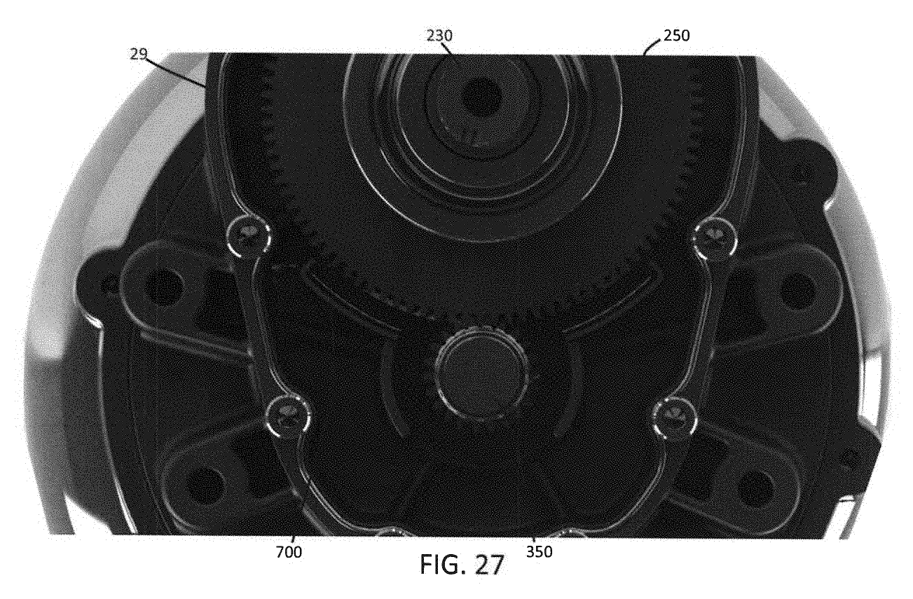

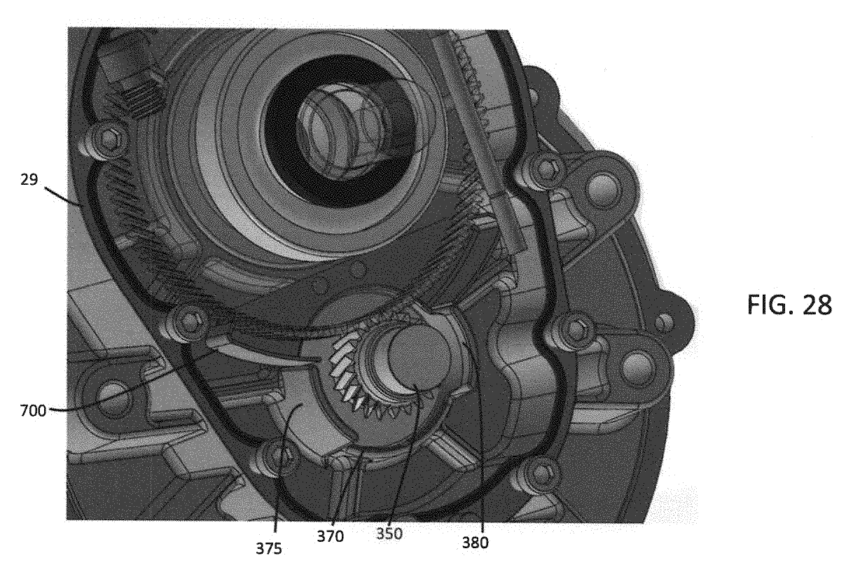

In some embodiments, the oil baffle 700 can be positioned in the housing 25. For example, FIGS. 25-28 illustrate the oil baffle of FIGS. 24A and 24B positioned in accordance with some further embodiments of the invention. FIG. 26 illustrates perspective view of the assembly of FIG. 25 with assembled input and impeller gears (325, 250) in accordance with some further embodiments of the invention. FIG. 27 illustrates a front view of the assembly shown in FIG. 26 in accordance with some further embodiments of the invention, and FIG. 28 illustrates perspective view of the assembly of FIG. 25 with impeller gear and input gears 325, 350 shown in outline in accordance with some further embodiments of the invention.

In some embodiments, the oil baffle 700 can be positioned in the lower housing 29 as shown at least in FIG. 25. In some embodiments, the oil baffle 700 can be positioned extending between the first guide wall 375 and second guide wall 380 with the lower edge extending around the aperture 29c. In some embodiments, the guides 720 can at least partially contain and/or guide, and/or control the flow of fluid between the assembled input and impeller gears 250, 325.

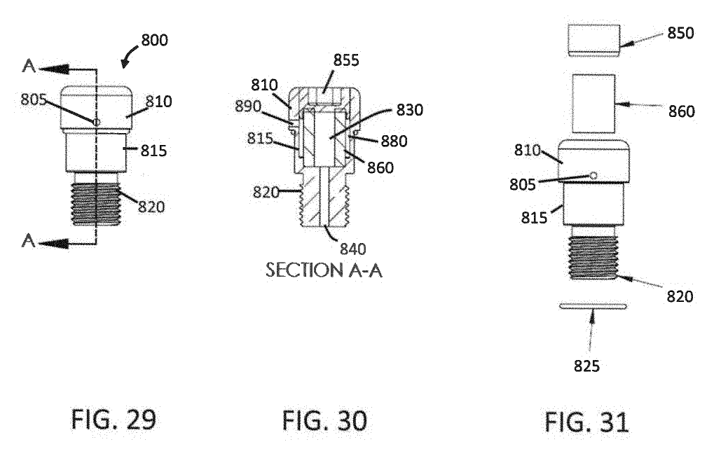

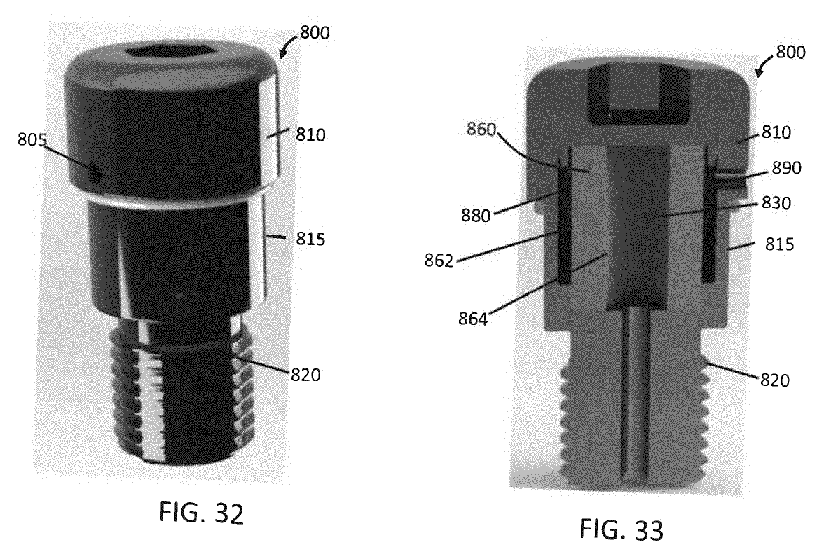

Some embodiments of the invention include a baffled vent plug. In some embodiments, the baffled vent plug includes a filter to baffle oil from exiting the supercharger vent (for example, during high G force cornering). For example, FIG. 29 illustrates a baffled vent plug 800 in accordance with some further embodiments of the invention. Further, FIG. 30 illustrates a section A-A of the baffled vent plug 800 as defined in FIG. 29 in accordance with some further embodiments of the invention, and FIG. 31 illustrates an exploded assembly view of the vent plug 800 of FIG. 29 in accordance with some further embodiments of the invention. FIG. 32 illustrates a front perspective view of the vent plug 800 of FIG. 29 in accordance with some further embodiments of the invention. FIG. 33 illustrates a cross-sectional perspective view of the vent plug 800 of FIG. 29 in accordance with some further embodiments of the invention.

In some embodiments, the vent plug 800 can comprise a body including a head portion 810 at one end, a center portion 815, and a threaded portion 820 at an opposite end. In some embodiments, a filter 860 can be positioned in a cavity 830, and a press-fit plug 850 can be placed into the cavity 830, sealing the head portion 810. In some embodiments, the filter 860 can comprises a mesh metal material. In some other embodiments, the filter 860 can comprise any conventional porous or semi-porous filter material.

In some embodiments, a hex cavity 855 can be included to enable securing the vent plug 800. In some embodiments, an o-ring 825 can be positioned over the threaded portion 820 to enable securing and sealing the vent plug 800 into the housing 25 of the supercharger 10. In some embodiments, the filter 860 can comprise filter channel 865. In some embodiments, when positioned in the cavity 830, the filter channel 865 can fluidly couple to channel 840 extending from the center portion 815 and exiting the threaded portion 820 as shown in FIGS. 30 and 33. Further, when positioned in the cavity 830, the outer walls 862 of the filter 860 can fluidly couple to the space 880 that substantially surrounds the filter 860, and fluidly couples to vent channel 890. In some embodiments, the vent plug 800 can be positioned through a wall of the gear housing 75. In some embodiments, the vent plug 800 can be fitted into the gear housing 75 in place of the plug with dipstick 80 or the plug 82. In other embodiments, the vent plug 800 can be positioned through any portion of the housing 25.

Any of the embodiments described herein can form part of a centrifugal or centrifugal-type supercharger. In other embodiments, any of the embodiments described herein can form part of a screw-type supercharger or a roots-type supercharger. Moreover, any of the embodiments described herein can form part of a positive displacement fluid pump.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

1. An assembly comprising;
a housing at least partially enclosing a compression chamber;
a variably-sized inlet fluidly coupled to the compression chamber;
an impeller at least partially positioned in the compression chamber;
an impeller shaft coupled to a portion of the impeller and forming an assembly, a portion of the assembly extending through an aperture of the housing; and
an oil baffle positioned substantially in the housing and at least partially surrounding the aperture.

2. The assembly of claim 1, wherein the variably-sized inlet is defined by an interchangeable or variable-size inlet constrictor.

3. The assembly of claim 2, wherein inlet constrictor comprises an inner wall defining an inlet region and outlet region, wherein a slope of the inner wall is defined by an angle from a plane parallel with the opening of the outlet region.

4. The assembly of claim 3, wherein the slope is about 78°.

5. The assembly of claim 3, wherein the slope is less than 90°.

6. The assembly of claim 1, wherein the housing comprises scroll-like upper housing at one end and a gear housing at an opposite end.

7. The assembly of claim 1, wherein the impeller is coupled to or integral with the impeller shaft, the impeller shaft coupled to or integral with an impeller gear positioned adjacent the oil baffle.

8. The assembly of claim 7, further comprising at least one oil guide including at least one coupled guide wall at least partially surrounding the impeller gear.

9. The assembly of claim 1, further comprising an anti-backlash gear assembly coupled to a gear of the impeller.

10. An assembly comprising:
a fluid compression chamber fluidly coupled to an interchangeable or variable inlet constrictor;
an input gear assembly comprising at least one input gear;
an impeller gear coupled to one or more gears of the input gear assembly; and
an oil baffle including guides configured to guide or control oil flow between the input gear and the impeller gear.

11. The assembly of claim 10, wherein the inlet constrictor comprises an inner wall defining an inlet region and outlet region, wherein a slope of the inner wall is defined by an angle from a plane parallel with an opening of the outlet region.

12. The assembly of claim 10, wherein the inlet constrictor is coupled to or includes an edge lip defining an inlet diameter of an inlet aperture.

13. The assembly of claim 11, wherein the slope is about 78°.

14. The assembly of claim 11, wherein the slope is about 90°.

15. The assembly of claim 11, further comprising at least one oil guide coupled to the oil baffle, the at least one oil guide including a curved wall at least partially surrounding the impeller gear.

16. The assembly of claim 10, further comprising an anti-backlash gear assembly coupled to the impeller gear.

17. An assembly comprising;
a housing including an output aperture;
a compression chamber at least partially surrounded by at least a portion of the housing;
an impeller at least partially positioned in the compression chamber, the impeller coupled to or including an impeller shaft coupled to an impeller gear;
a variable or interchangeable inlet constrictor defining an inlet aperture, the inlet aperture fluidly coupled to the compression chamber; and
an oil baffle including guides configured to guide or control oil flow in an area located substantially between the input gear and impeller gear.

18. The assembly of claim 17, further comprising at least one oil guide integrally coupled to the oil baffle.

19. The assembly of claim 17, wherein the inlet constrictor includes an outlet region comprising an aperture with an outlet diameter, the outlet diameter being circumferentially defined by a coupling between a bottom surface and an inner wall of the inlet constrictor.

20. An assembly of claim 19, wherein the inner wall is sloped by an angle from a plane parallel with the opening of the outlet region, the angle being at least of about 78° or less than 90°.
